(19) United States
(12) Patent Application Publication
(10) Pub. No.: US 2007/0100675 A1
(43) Pub. Date: May 3, 2007

(54) Supply chain workload balancing

(76) Inventors: Boris Kneisel, Mannheim (DE); Erik Luengen, Flein (DE)

Correspondence Address: FISH & RICHARDSON, P.C., PO BOX 1022, MINNEAPOLIS, MN, 55440-1022, US

(21) Appl. No.: 11/267,224

(22) Filed: Nov. 3, 2005

(51) Int. Cl. G06F 9/46

(52) U.S. Cl. 705/8

(57) ABSTRACT

Information may be provided to user regarding an issued sales order quote for an entity. Thereafter, an input may be received from the user assigning the issued sales order quote with a conversion probability factor indicating a likelihood that the issued sales order quote being converted into a sales order. Data identifying the issued sales order quote and the conversion probability factor may be transmitted over a communications network to a remote application in a form that enables the remote application, when initiating one or more machine-executable processes to allocate resources to fulfill the at least one issued sales order quote, to make use of the transmitted data in executing the processes.

### TECHNICAL FIELD

The subject matter described herein relates to mechanisms to reduce inefficiencies among various supply chain units of an enterprise.

### BACKGROUND

Demand order variabilities in a supply chain may be amplified as they move up the supply chain. Such a phenomenon, referred to as a bullwhip effect, was popularized in Hau L Lee, V Padmanabhan and Seungjin Whang, “The Bullwhip Effect In Supply Chains”, Sloan Management Review, Volume 38, Issue 3, pp. 93-102 (Spring 1997). Such variabilities can results in inefficiencies such as excessive inventory investment, poor customer service, lost revenues, misguided capacity planning, inactive transportation, missed production schedules, and the like.

There are four commonly attributed factors that can result in the bullwhip effect: demand forecast updating, order batching, price fluctuation, and rationing and shortage gaming. Demand forecast updating relates to product forecasting for production scheduling, capacity planning, inventory control, and material requirements planning. Order batching relates to the placement of orders with an upstream organization based on monitored inventory. Price fluctuations may cause a bullwhip effect in situations in which a customer purchases larger quantities of a product when a price for the products is low, and stops purchasing products until it has depleted its inventory when prices increase. Rationing and shortage gaming can occur when a manufacturer rations its supplies if product demand exceeds supply which can cause some customers to exaggerate their requirements.

While the bullwhip effect has traditionally been analyzed across multiple organizations (customer, manufacturer, etc.), similar effects may also occur within an organization. Such effect may be magnified when goods are produced in a location distant from a corresponding sales unit (e.g., off-shore such as Asia). For example, a micro-bullwhip effect may occur between demand management functions (e.g., sales department) and supplying units within the organization (e.g., distribution center or production department). Increasing the transparency between the demand management functions and supplying units can act to minimize the micro-bullwhip effect.

### SUMMARY

In a first aspect, information may be provided to a user regarding at least one issued sales order quote for an entity. Thereafter, an input may be received from the user assigning the at least one issued sales order quote with a conversion probability factor indicating a likelihood of the at least one issued sales order quote being converted into a sales order. Data that identifies the at least one issued sales order quote and the conversion probability factor may subsequently be transmitted over a communications network to a remote application in a form that enables the remote application, when initiating one or more machine-executable processes to allocate resources to fulfill the at least one issued sales order quote, to make use of the transmitted data in executing the processes.

In some variations, preliminarily, a user-initiated request may be received to generate a quotation. A computer application associated with a sales unit may then poll a production scheduling application over the communications network to identify an amount of resources required to fulfill the quotation and to determine a block of time in which the identified amount of resources is available. Thereafter, the at least one issued sales order quote may be generated based on the determined block of time.

The at least one issued sales order quote may be associated with two or more products or services. In such arrangements, a conversion probability factor may be individually assigned to each of the products or services (or optionally to groups or other classifications of the products or services). All of these conversion probability factors may be transmitted to the remote application in order to facilitate the potential fulfillment of the at least one issued sales order quote.

In order to facilitate a user associated with sales functions to be provided with an overview of outstanding sales orders quotes, a chart may be displayed having a first axis providing a span of values of sales orders and a second axis providing a span of a number of days of validity of sales order quotes. A graphical user element associated with the at least one issued sales order quote may also be provided (e.g., centered) at a coordinate in the chart corresponding to a value of the at least one issued sales order quote and a number of remaining days for which the at least one sales order quote may be converted into a sales order.

A graphical user interface element associated with the at least one issued sales order quote may be used to provide information regarding the at least one issued sales order quote. For example, information such as whether the entity is a repeat customer, a time in which previous sales order quotes have been converted, whether the sales order quotes were partially or fully accepted by the entity, whether line items were increased or decreased, whether modifications to pricing were made, whether modifications to product configurations were implemented, a URL or other link to a copy of the sales order quote, and the like. Such information may be displayed, for example, in a sales order quote window which is provided when the graphical user interface element is activated.

The user may also be presented with a default conversion probability factor based on previous sales order conversion statistics for the entity. This default value may be presented, for example, in a probability window which includes a prompt for a user to either modify this default value or to ratify it (e.g., accept without changing)

In some variations, an intermediate application may receive the transmitted data over the communications network. This intermediate application may determine an amount of production resources to allocate for the at least one issued sales order quote and the conversion probability factor. Thereafter, the intermediate application may forward data identifying the at least one issued sales order quote and the determined amount of production resources to allocate for the at least one issued sales order quote to the remote application. Alternatively, the intermediate application may determine an amount of available supply to reserve for the at least one issued sales order quote and forward data identifying the at least one issued sales order quote and the determined amount of supply to reserve for the at least one issued sales order quote to the remote application.

In another aspect, an apparatus may comprise a graphical user interface and a transmitter. The graphical user interface may be operable to provide information to a user regarding at least one issued sales order quote and to receive an input from the user assigning the at least one issued sales order quote with a conversion probability factor indicating a likelihood of the at least one issued sales order quote being converted into a sales order. The transmitter may be operable to transmit data identifying the at least one issued sales order quote and the conversion probability factor over a communications network to a remote application in a form that enables the remote application, when initiating one or more machine-executable processes to allocate resources to fulfill the at least one issued sales order quote, to make use of the transmitted data in executing the processes.

In an interrelated aspect, information may be provided to a user regarding each of a plurality of goods offered in an issued sales order quote. Subsequently, an input may be received from the user assigning each of the plurality of goods with a conversion probability factor indicating a likelihood of the sales order quote being converted into a sales order that includes the goods. Data may then be transmitted that identifies the issued sales order quote and each of the goods and their corresponding conversion probability factors over a communications network to a remote application in a form that enables the remote application, when initiating one or more machine-executable processes to allocate resources to fulfill the issued sales order quote, to make use of the transmitted data in executing the processes.

Computer program products, tangibly embodied in information carriers are also described. Such computer program products cause a data processing apparatus to conduct one or more operations described herein.

Similarly, systems are also described that may include a processor and a memory coupled to the processor. The memory may encode one or more programs that cause the processor to perform one or more of the method acts described herein.

The subject matter described herein provides many advantages. For example, by associating a conversion probability factor for each sales order quote, greater synchronization of supply chain elements may be effectuated thereby minimizing excess supply and/or allocation of production resources.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method of associating a sales order quote with a conversion probability factor to facilitate allocation of resources to fulfill the sales order quote;

FIG. 2 is a schematic diagram of an apparatus operable to associate a sales order quote with a conversion probability factor to facilitate allocation of resources to fulfill the sales order quote;

FIG. 3 is a graphical user interface for receiving a conversion probability factor for a sales order quote from a user useful for understanding and implementing the subject matter described herein; and

FIG. 4 is a chart illustrating various supply and demand scenarios useful for understanding and implementing the subject matter described herein.

Like reference symbols in the various drawings indicate like elements.

### DETAILED DESCRIPTION

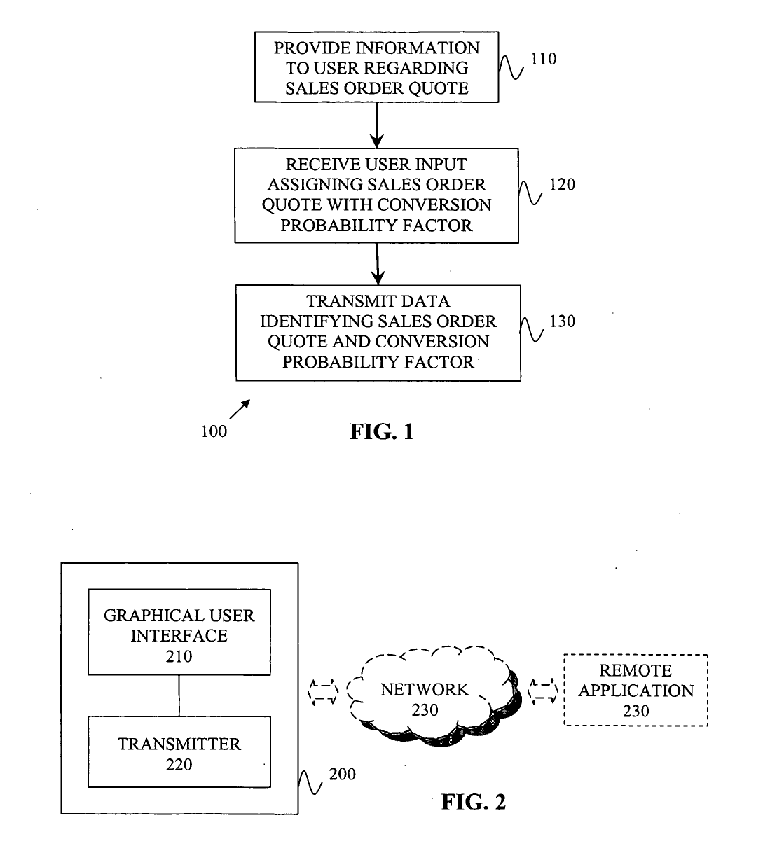

FIG. 1 is a process flow diagram of a method 100, in which, at 110, information regarding at least one issued sales order quote for an entity is provided to a user. In response to this information, at 120, an input is received from the user assigning the at least one issued sales order quote with a conversion probability factor indicating a likelihood of the at least one issued sales order quote being converted into a sales order. Subsequently, at 130, data that identifies the at least one issued sales order quote and the conversion probability factor is transmitted over a communications network to a remote application. This data is in a form that enables the remote application, when initiating one or more machine-executable processes to allocate resources to fulfill the at least one issued sales order quote, to make use of the transmitted data in executing the processes.

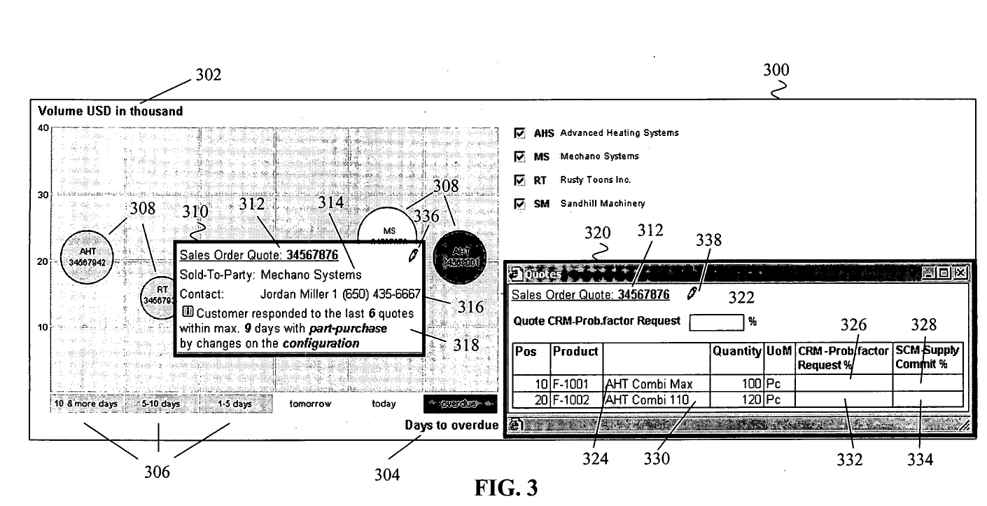

FIG. 2 is a schematic diagram of an apparatus 200 comprising a graphical user interface 210 and a transmitter 220. The graphical user interface 210 is operable to provide information to a user regarding at least one issued sales order quote and to receive an input from the user assigning the at least one issued sales order quote with a conversion probability factor indicating a likelihood of the at least one issued sales order quote being converted into a sales order. The transmitter 220 is operable to transmit data identifying the at least one issued sales order quote and the conversion probability factor over a communications network 230 to a remote application 240 in a form that enables the remote application 240, when initiating one or more machine-executable processes to allocate resources to fulfill the at least one issued sales order quote, to make use of the transmitted data in executing the processes.

The following provides information useful for understanding and implementing the subject matter described herein as well as optional variations that may be implemented singly or in combination depending on the desired configuration.

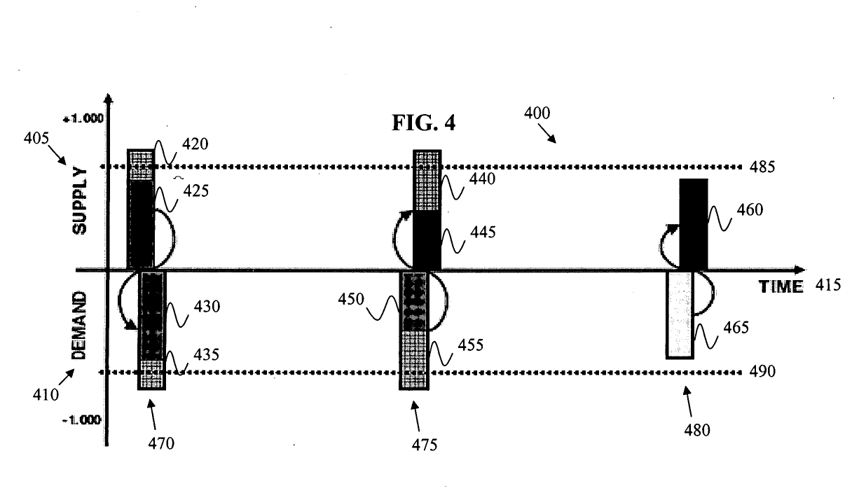

FIG. 3 illustrates an example graphical user interface window 300 in which a sales person may monitor outstanding sales order quotes. The window 300 may illustrates sales-volumes (in US dollars) on the Y-axis 302 vs. days to overdue (e.g., quote validity dates) of the issued sales quotes on the X-axis 304. The X-axis 304 may comprise a set of columns allowing the clustering of sales-quotes in groups by validity dates 306 (e.g. “10 & more days/5-10 days/1-5 days/tomorrow/today/overdue” etc.). Individual sales quotes 308 may be represented as circle-shaded “bubbles” with their diameter indicating the expected sales volume or a relative measurement based on some other statistics.

The salesperson may activate a graphical user interface element associated with a sales order quote 308 in the 1-5 days to overdue column 306 to open a sales order quote window 310. The graphical user interface element may be activated by moving (and optionally maintaining) the mouse or cursor over the circle-shaded bubble associated with the sales order quote 308 and/or it may be activated by “clicking” the sales order quote 308 using the mouse or cursor. The sales order quote window 310 may be used to determine whether it is still likely that the customer will place a sales order corresponding to the sales quote 308 after 15 out of 20 days of the validity period have already passed.

The sales order quote window 310 may include information identifying (i) the sales order quote 312 (which may additionally include a link to a web document corresponding to the sales order quote and/or information such as: line-item number, product identification number, product name, offered quantity, unit-of-measure, etc.); (ii) the customer 314; (iii) a contact person for the customer 316; and (iv) past historical sales order quote conversion statistics regarding the customer 318.

The statistics 318 may be based on customer behavior relating to previously issued sales order quotes. For example, the statistics 318 may identify whether the customer has been doing repeat business with the selling organization (e.g., the customer placed five sales orders within the last ten weeks/months/quarters, etc.). The statistics 318 may also identify a success rate based on the amount of outgoing sales quotes with this customer that have been converted into sales orders (e.g., 20% or ratio of 1:5, etc.). Furthermore, the statistics 318 may identify a response time based on an amount of time from which the sales order quote was initiated until receipt a corresponding sales orde (e.g., an average of nine days with a deviation of 1.5 days).

The statistics 318 may also identify whether the customer accepted the offered sales quote or only partially accepted the sales order quote (which may also indicate whether the sales order modified the sales order quote) (e.g., sales order quote was partially accepted in 12 out of 20 cases, etc.). This partial acceptance information may be useful in identifying whether certain items were deleted from previous sales order quotes thereby increasing order processing costs due to manual interaction needed to make such changes. In addition, the partial acceptance information may be used so that a salesperson does not proffer a sales order quote with a lot of items. Optionally, the statistics 318 may indicate a metric relating to increased/reduced the item line quantities, when converting a sales order quote (e.g., in 3 out of 8 cases, the number of items were increased, etc.). The information relating to changes in the number of items may also be useful in determining whether a customer is seeking to indirectly learn information regarding bulk discounts (i.e., customer requests large amounts of a product in order to determine the discount pricing schedule in order to negotiate reduced rate for smaller quantities). Moreover, the number of item changes may be useful to minimize rationing and shortage gaming when supply is low and in which the customer intentionally requests a sales order quote for a higher number of units with the understanding that they will only receive a fraction of the requested units.

The statistics 318 may be used by the salesperson to minimize a micro-bullwhip effect by filtering out requested demand prior to issuing a sales order quote and/or prior to converting a sales order quote into a sales order. This arrangement ensures that a greater percentage of actual demand is passed on from demand management functions to supplying units within an organization.

In some variations, additional information may be displayed characterizing past purchasing behavior of the customer. For example, information may be displayed indicating that the customer converted a most recent sales-quote into a sales order after additional negotiation (five phone calls, two in-person meetings, etc.). Moreover, additional information may be provided that characterizes the negotiation tactics of the customer, such as the customer initially requested a discount of 25% but ultimately settled on a 7% discount, and the like. Yet further, information may be provided which indicates whether there were any modifications to the goods/services identified in the initial sales quote after converting to a sales order.

Sales order quote window 310 may include a graphic element 336 such as an icon in the shape of a pencil. By activating the graphic element (e.g., by clicking on it), the sales order quote window 310 may stay open (i.e., it will not close after a cursor is moved outside of its boundaries) and probability window 320 may be opened.

Based on the information within sales order quote window 310, a user may be able to determine a probability that the identified sales quote 312 will be converted into one or more sales orders. This probability may discount, for example, unreasonably high amounts of demand that might be requested by a potential customer for a variety of reasons (e.g., obtain discounted pricing, premature sales orders, etc.). After the probability is determined, a user may enter a probability for the order as a whole in prompt 322 within the probability window 320. Alternatively, a user may enter in individual probabilities on a line-item basis for each product 324, 330 within the sales order quote within corresponding prompts 326, 332 within the probability window 320. Optionally, a user intermediate the sales unit and the production unit may also enter in a supply level commitment factor for each of the products 324, 330 within corresponding prompts 332, 334. Such supply level commitment factors may additionally used to determine a level at which a supply-chain planning and/or production department will commit resources to fulfill the sales order quote.

In some variations, each of prompts 322, 326, 328, 332, 334 may be populated with default values when probability window 320 is first rendered. These default values may be based on past sales order conversion characteristics.

The entered values in one or more of the prompts 322, 326, 328, 332, 334 may be transmitted, via a communications network to one or more of a supply chain unit, a logistics unit, and a production unit. In some variations, the entered values are provided as follows:
sales-quote line-item qty[UoM]×probability-factor[%]=transfer-of-req.−qty[UOM]

FIG. 4 illustrates a chart 400 in which three different supply and demand scenarios 470, 475, 480 are presented. Such a chart 400 may be presented to user in the form of a graphical user interface or other display mechanism. The chart 400 includes a vertical axis which identifies a magnitude of supply 405 and a magnitude of demand 410 and a horizontal axis which identifies a magnitude of time 415. Dotted line 485 indicates a maximum capacity of a warehouse to store available stock and dotted line 490 indicates a maximum production capacity to produce the goods.

Scenario 470 illustrates an arrangement in which goods from stock are stocked and sold based on demand. With this variation, reference 425 indicates an amount of available stock (e.g., goods on hand) which has been allocated based on an amount of demand according to a conversion probability factor for a particular sales order quote and reference 420 indicates an amount of available stock which exceeds the allocated available stock. Reference 430 indicates an amount of demand allocated to the sales order quote based on the conversion probability factor and reference 435 indicates an additional amount of demand that represents if all of the demand within the sales order quote is converted into a sales order (e.g., a 100% probability conversion factor). When goods are being manufactured in advanced of demand, the goal is to only make as much as product as there will be realized demand. By assigning a conversion probability factor to a sales order quote, a more accurate estimate of realized demand may be provided to a production unit so that an optimal amount of supply of the goods are produced.

Scenario 475 illustrates an arrangement in which goods are made to order based on sales orders. Reference 445 indicates an amount of production resources which have been allocated to a sales order quote based on the corresponding conversion probability factor and reference 440 indicates an additional amount of production resources that would be required to completely fulfill the sales order quote. Reference 450 indicates an amount of transferred demand from the sales order quote based on the associated conversion probability factor and reference 455 indicates a maximum expected order size for the sales order quote (e.g., 100% conversion probability factor). Excessive allocation of demand from a sales order quote may result in a production unit unnecessarily reserving production resources to fulfill the sales order quote and/or producing more goods than are required. Optimally, only an amount of goods sufficient to realize the demand as adjusted by the associated probability conversion factor would need to be produced in order to fulfill the sales order.

Scenario 480 illustrates an arrangement in which all demand associated with a sales order quote 465 is realized to generate product 460 (i.e., the sales order quote has an associated conversion probability factor of 100%). This scenario 480 illustrates an optimal arrangement in which demand 465 within the sales order quote is fully realized without overallocating resources to fulfill the corresponding sales order.

Chart 400 may be used by a user or entity intermediate the sales unit and the production unit to determine how to allocate available stock and/or production resources to fulfill potential sales orders. In one variation, chart 400 reflects a commitment by a supply-chain unit and/or a production unit a commitment for the demand requested by the sales unit (e.g., entry into prompts 328, 334, etc.) in terms of quantity, quality, due-date, cost, and the like. Optionally, entities intermediate the sales unit and the production unit should only be able to modify or otherwise apply an amount of requested demand (e.g., prompts 328, 334) and not be able to modify other characteristics of the sales order such as delivery date, product amounts, and the like.

The sales order quote may be generated in traditional fashion based on guidelines provided by a sales unit providing an average lead time based on current forecasts. In other variations, a user may initiate a request to generate a quotation to provide certain products. A production scheduling application accessible via a communications network may be polled, by an application associated with the sales unit in order to identify a time in which a block of resources amount of resources required to fulfill the quotation are available. This timing information may then be used to issue the sales order quote. In addition or in the alternative, the user may provide a probability conversion factor when generating a sales order quote which may be used to select a lead time required to produce the requested goods and/or to select an amount of time in which the sales order quote shall be valid.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor. To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, a sales unit and a production unit need not be within a single enterprise, provided that visibility into available resources is provided by the production unit to the sales unit. Moreover, the logic flow depicted in the accompanying figures and described herein do not require the particular order shown, or sequential order, to achieve desirable results. Other embodiments may be within the scope of the following claims.

What is claimed is:

1. A computer-implemented method comprising:
providing information to a user regarding at least one issued sales order quote for an entity;
receiving an input from the user assigning the at least one issued sales order quote with a conversion probability factor indicating a likelihood of the at least one issued sales order quote being converted into a sales order; and
transmitting data identifying the at least one issued sales order quote and the conversion probability factor over a communications network to a remote application in a form that enables the remote application, when initiating one or more machine-executable processes to allocate resources to fulfill the at least one issued sales order quote, to make use of the transmitted data in executing the processes.

2. A method as in claim 1, further comprising:
receiving a user-initiated request to generate a quotation for the at least one issued sales order quote;
polling a production scheduling application over the communications network to identify an amount of resources required to fulfill the quotation and to determine a block of time in which the identified amount of resources is available; and
generating the at least one issued sales order quote with a fulfillment date based on the determined block of time.

3. A method as in claim 1, wherein the at least one issued sales order quote is associated with a plurality of products or services;
wherein the receiving an input from the user assigning the at least one issued sales order quote with a conversion probability factor indicating a likelihood of the at least one issued sales order quote being converted into a sales order comprises:
receiving input from the user assigning each of the plurality of products or services in the at least one issued sales order quote with a conversion probability factor indicating a likelihood of the goods or services in at least one issued sales order quote forming part of a sales order; and
wherein the transmitted data comprises each of the conversion probability factors associated with the goods or services.

4. A method as in claim 1, further comprising:
displaying a chart having a first axis providing a span of values of sales orders and a second axis providing a span of a number of days of validity of sales order quotes; and
providing a graphical user element associated with the at least one issued sales order quote at a coordinate in the chart corresponding to a value of the at least one issued sales order quote and a number of remaining days for which the at least one sales order quote may be converted into a sales order.

5. A method as in claim 1, wherein the providing information to a user regarding at least one issued sales order quote comprising:
providing a graphical user interface with at least one graphical user element associated with the at least one issued sales order quote.

6. A method as in claim 5, further comprising:
receiving a user input activating the at least one graphical user interface element; and
displaying a sales order quote window when the user activates the graphical user interface element.

7. A method as in claim 6, wherein the sales order quote window comprises:
a link to a document containing the at least one sales order quote accessible over the communications network.

8. A method as in claim 1, wherein the information provided includes one or more statistics relating to previous sales order quote conversions.

9. A method as in claim 1, further comprising:
providing the user with a default conversion probability factor based on past sales order conversion statistics for the entity.

10. A method as in claim 9, wherein the receiving an input from the user assigning the at least one issued sales order quote with a conversion probability factor indicating a likelihood of the at least one issued sales order quote being converted into a sales order comprises: receiving an input from the user modifying the default conversion probability factor.

11. A method as in claim 9, wherein the receiving an input from the user assigning the at least one issued sales order quote with a conversion probability factor indicating a likelihood of the at least one issued sales order quote being converted into a sales order comprises: receiving an input from the user ratifying the default conversion probability factor.

12. A method as in claim 1, wherein an intermediate application receives the transmitted data and determines amount of production resources to allocate for the at least one issued sales order quote based on the conversion probability factor, and further comprising:
forwarding, by the intermediate application to the remote application, data identifying the at least one issued sales order quote and the determined amount of production resources to allocate for the at least one issued sales order quote.

13. A method as in claim 1, wherein an intermediate application receives the transmitted data and determines amount of available supply to reserve for the at least one issued sales order quote based on the conversion probability factor, and further comprising:
forwarding, by the intermediate application to the remote application, data identifying the at least one issued sales order quote and the determined amount of supply to reserve for the at least one issued sales order quote.

14. An apparatus comprising:
a graphical user interface to provide information to a user regarding at least one issued sales order quote and to receive an input from the user assigning the at least one issued sales order quote with a conversion probability factor indicating a likelihood of the at least one issued sales order quote being converted into a sales order; and
a transmitter to transmit data identifying the at least one issued sales order quote and the conversion probability factor over a communications network to a remote application in a form that enables the remote application, when initiating one or more machine-executable processes to allocate resources to fulfill the at least one issued sales order quote, to make use of the transmitted data in executing the processes.

15. An apparatus as in claim 14, wherein the graphical user interface is further operable to display a chart having a first axis providing a span of values of sales orders and a second axis providing a span of a number of days of validity of sales order quotes and to provide a graphical user element associated with the at least one issued sales order quote at a coordinate in the chart corresponding to a value of the at least one issued sales order quote and a number of remaining days for which the at least one sales order quote may be converted into a sales order.

16. A computer program product, tangibly embodied in an information carrier, the computer program product being operable to cause a data processing apparatus to:
provide information to a user regarding at least one issued sales order quote for an entity;
receive an input from the user assigning the at least one issued sales order quote with a conversion probability factor indicating a likelihood of the at least one issued sales order quote being converted into a sales order; and
transmit data identifying the at least one issued sales order quote and the conversion probability factor over a communications network to a remote application in a form that enables the remote application, when initiating one or more machine-executable processes to allocate resources to fulfill the at least one issued sales order quote, to make use of the transmitted data in executing the processes.

17. A computer program product as in claim 16, wherein the computer program product being further operable to cause a data processing apparatus to:
receive a user-initiated request to generate a quotation for the at least one issued sales order quote;
poll a production scheduling application over the communications network to identify an amount of resources required to fulfill the quotation and to determine a block of time in which the identified amount of resources is available; and
generate the at least one issued sales order quote with a fulfillment date based on the determined block of time.

18. A computer program product as in claim 16, wherein the at least one issued sales order quote is associated with a plurality of products or services;
wherein the receiving an input from the user assigning the at least one issued sales order quote with a conversion probability factor indicating a likelihood of the at least one issued sales order quote being converted into a sales order comprises:
receiving input from the user assigning each of the plurality of products or services in the at least one issued sales order quote with a conversion probability factor indicating a likelihood of the goods or services in at least one issued sales order quote forming part of a sales order; and
wherein the transmitted data comprises each of the conversion probability factors associated with the goods or services.

19. A computer program product as in claim 16, wherein the computer program product being further operable to cause a data processing apparatus to:
display a chart having a first axis providing a span of values of sales orders and a second axis providing a span of a number of days of validity of sales order quotes; and
provide a graphical user element associated with the at least one issued sales order quote at a coordinate in the chart corresponding to a value of the at least one issued sales order quote and a number of remaining days for which the at least one sales order quote may be converted into a sales order.

20. A computer program product as in claim 16, wherein provide information to a user regarding at least one issued sales order quote comprises:
provide a graphical user interface with at least one graphical user element associated with the at least one issued sales order quote;
receive a user input activating the at least one graphical user interface element; and
display a sales order quote window when the user activates the graphical user interface element.
